(19) United States
(12) Patent Application Publication
(10) Pub. No.: US 2025/0302118 A1
(43) Pub. Date: Oct. 2, 2025

(54) AEROSOL-GENERATING DEVICE AND OPERATION METHOD THEREOF

(71) Applicant: KT&G Corporation, Daejeon (KR)

(72) Inventors: Byungsung CHO, Gyeonggi-do (KR); Jongsub LEE, Gyeonggi-do (KR); Soonhwan JUNG, Daejeon (KR)

(21) Appl. No.: 18/863,261

(22) PCT Filed: May 10, 2023
(86) PCT No.: PCT/KR2023/006367

§ 371 Date: Nov. 5, 2024

(30) Foreign Application Priority Data
May 11, 2022 (KR) 10-2022-0058005
Sep. 28, 2022 (KR) 10-2022-0123663

(51) Int. Cl. A24F 40/57; A24F 40/10; A24F 40/42; A24F 40/44; A24F 40/465; A24F 40/51; A24F 40/53; A24F 40/60

(52) U.S. Cl. CPC A24F 40/57; A24F 40/10; A24F 40/42; A24F 40/44; A24F 40/465; A24F 40/51; A24F 40/53; A24F 40/60

(57) ABSTRACT

An aerosol-generating device and an operation method thereof are disclosed. The aerosol-generating device of the disclosure includes a first container including a wick and a heater, a second container configured to store a liquid, a first sensor configured to detect a coupling between the first container and the second container, a second sensor configured to sense a temperature of the heater and a controller. The first container and the second container are detachably coupled to each other. The controller is configured to control so that initial power corresponding to coupling of the first container and the second container is supplied to the heater, based on the first container and the second container which have been separated from each other being coupled, and determine at least one of whether the liquid is absorbed into the wick or whether the liquid in the second container is exhausted, based on a temperature of the heater corresponding to supply of the initial power.

### TECHNICAL FIELD

The present disclosure relates to an aerosol-generating device and an operation method thereof.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to provide an aerosol-generating device capable of allowing a component storing a liquid and a component including a wick to be replaced independently of each other.

It is still another object of the present disclosure to provide an aerosol-generating device capable of allowing a liquid to flow smoothly to a wick for generating aerosol.

It is still another object of the present disclosure to provide an aerosol-generating device capable of notifying a user that a liquid has sufficiently flowed into a wick.

It is still another object of the present disclosure to provide an aerosol-generating device capable of reducing unnecessary power consumption.

It is still another object of the present disclosure to provide an aerosol-generating device capable of determining whether a liquid is absorbed into a wick before generating an aerosol.

It is still another object of the present disclosure to provide an aerosol-generating device capable of determining whether a liquid is stored in a cartridge prior to generating the aerosol.

### Solution to Problem

An aerosol-generating device according to an aspect of the present disclosure for accomplishing the above and other objects may include a first container including a wick and a heater, a second container configured to store a liquid, a first sensor configured to detect a coupling between the first container and the second container, a second sensor configured to sense a temperature of the heater and a controller. The first container and the second container may be detachably coupled to each other. The controller may control so that initial power corresponding to coupling of the first container and the second container is supplied to the heater, based on the first container and the second container which have been separated from each other being coupled, and determine at least one of whether the liquid is absorbed into the wick or whether the liquid in the second container is exhausted, based on a temperature of the heater corresponding to supply of the initial power.

### Advantageous Effects of Invention

According to at least one of embodiments of the present disclosure, it may be possible to allow a liquid to flow smoothly to a wick for generating aerosol.

According to at least one of embodiments of the present disclosure, it may be possible to allow a liquid to flow smoothly to a wick for generating aerosol.

According to at least one of embodiments of the present disclosure, it may be possible to notify a user that a liquid has sufficiently flowed into a wick.

According to at least one of embodiments of the present disclosure, it may be possible to reduce unnecessary power consumption.

According to at least one of embodiments of the present disclosure, it may be possible to determine whether a liquid is absorbed into a wick before generating an aerosol.

According to at least one of embodiments of the present disclosure, it may be possible to determine whether a liquid is stored in a cartridge prior to generating the aerosol.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2 to 6 are views for explaining an aerosol-generating device according to embodiments of the present disclosure;

FIG. 7 is a flowchart showing an operation method of the aerosol-generating device according to an embodiment of the present disclosure; and

FIGS. 8 to 13 are diagrams for explaining the operation of an aerosol-generating device according to an embodiment of the present disclosure.

### MODE FOR THE INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

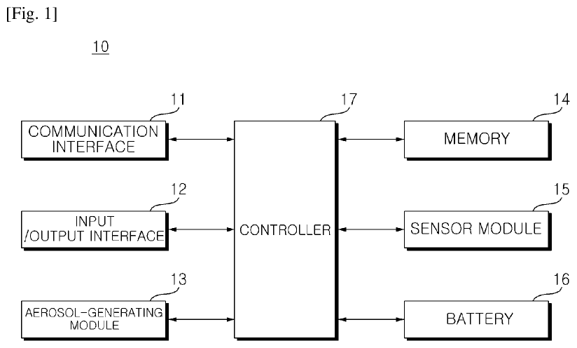

FIG. 1 is a block diagram of an aerosol-generating device according to an embodiment of the present disclosure.

Referring to FIG. 1, an aerosol-generating device 100 may include a communication interface 110, an input/output interface 120, an aerosol-generating module 130, a memory 140, a sensor module 150, a battery 160, and/or a controller 170.

In one embodiment, the aerosol-generating device 100 may be composed only of a main body. In this case, components included in the aerosol-generating device 100 may be located in the main body. In another embodiment, the aerosol-generating device 100 may be composed of a cartridge, which contains an aerosol-generating substance, and a main body. In this case, the components included in the aerosol-generating device 100 may be located in at least one of the main body or the cartridge.

The communication interface 110 may include at least one communication module for communication with an external device and/or a network. For example, the communication interface 110 may include a communication module for wired communication, such as a Universal Serial Bus (USB). For example, the communication interface 110 may include a communication module for wireless communication, such as Wireless Fidelity (Wi-Fi), Bluetooth, Bluetooth Low Energy (BLE), ZigBee, or nearfield communication (NFC).

The input/output interface 120 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 120 may transmit data corresponding to a command input by the user through the input device to another component (or other components) of the aerosol-generating device 1000. The input/output interface 120 may output information corresponding to data received from another component (or other components) of the aerosol-generating device 100 through the output device.

The aerosol-generating module 130 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 130 may include at least one heater (not shown).

The aerosol-generating module 130 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 130 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 130 may generate ultrasonic vibrations to thereby generate an aerosol from the aerosol-generating substance.

The aerosol-generating device 100 may be referred to as a cartomizer, an atomizer, or a vaporizer.

The memory 140 may store programs for processing and controlling each signal in the controller 170. The memory 140 may store processed data and data to be processed.

For example, the memory 140 may store applications designed for the purpose of performing various tasks that can be processed by the controller 170. The memory 140 may selectively provide some of the stored applications in response to the request from the controller 170.

For example, the memory 140 may store data on the operation time of the aerosol-generating device 1000, the maximum number of puffs, the current number of puffs, the number of uses of battery 160, at least one temperature profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 140 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 150 may include at least one sensor.

For example, the sensor module 150 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 150 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 150 may include a sensor for sensing the temperature of the heater included in the aerosol-generating module 130 and the temperature of the aerosol-generating substance (hereinafter referred to as a “temperature sensor”). In this case, the heater included in the aerosol-generating module 130 may also serve as the temperature sensor. For example, the electro-resistive material of the heater may be a material having a predetermined temperature coefficient of resistance. The sensor module 150 may measure the resistance of the heater, which varies according to the temperature, to thereby sense the temperature of the heater.

For example, in the case in which the main body of the aerosol-generating device 100 is formed to allow a stick to be inserted thereinto, the sensor module 150 may include a sensor for sensing insertion of the stick (hereinafter referred to as a “stick detection sensor”).

For example, in the case in which the aerosol-generating device 100 includes a cartridge, the sensor module 150 may include a sensor for sensing mounting/demounting of the cartridge and the position of the cartridge (hereinafter referred to as a “cartridge detection sensor”).

In this case, the stick detection sensor and/or the cartridge detection sensor may be implemented as an inductance-based sensor, a capacitive sensor, a resistance sensor, or a Hall sensor (or Hall IC) using a Hall effect.

For example, the sensor module 150 may include a voltage sensor for sensing a voltage applied to a component (e.g. the battery 160) provided in the aerosol-generating device 100 and/or a current sensor for sensing a current.

The battery 160 may supply electric power used for the operation of the aerosol-generating device 100 under the control of the controller 170. The battery 160 may supply electric power to other components provided in the aerosol-generating device 1000. For example, the battery 160 may supply electric power to the communication module included in the communication interface 110, the output device included in the input/output interface 120, and the heater included in the aerosol-generating module 130.

The battery 160 may be a rechargeable battery or a disposable battery. For example, the battery 160 may be a lithium-ion (Li-ion) battery or a lithium polymer (Li-polymer) battery. However, the present disclosure is not limited thereto. For example, when the battery 160 is rechargeable, the charging rate (C-rate) of the battery 160 may be 100 C, and the discharging rate (C-rate) thereof may be 100 C to 20 C. However, the present disclosure is not limited thereto. Also, for stable use, the battery 160 may be manufactured such that 80% or more of the total capacity may be ensured even when charging/discharging is performed 2000 times.

The aerosol-generating device 100 may further include a protection circuit module (PCM) (not shown), which is a circuit for protecting the battery 160. The protection circuit module (PCM) may be disposed adjacent to the upper surface of the battery 160. For example, in order to prevent overcharging and overdischarging of the battery 160, the protection circuit module (PCM) may cut off the electrical path to the battery 160 when a short circuit occurs in a circuit connected to the battery 160, when an overvoltage is applied to the battery 160, or when an overcurrent flows through the battery 160.

The aerosol-generating device 100 may further include a charging terminal to which electric power supplied from the outside is input. For example, the charging terminal may be formed at one side of the main body of the aerosol-generating device 1000. The aerosol-generating device 100 may charge the battery 160 using electric power supplied through the charging terminal. In this case, the charging terminal may be configured as a wired terminal for USB communication, a pogo pin, or the like.

The aerosol-generating device 100 may wirelessly receive electric power supplied from the outside through the communication interface 110. For example, the aerosol-generating device 100 may wirelessly receive electric power using an antenna included in the communication module for wireless communication. The aerosol-generating device 100 may charge the battery 160 using the wirelessly supplied electric power.

The controller 170 may control the overall operation of the aerosol-generating device 1000. The controller 170 may be connected to each of the components provided in the aerosol-generating device 1000. The controller 170 may transmit and/or receive a signal to and/or from each of the components, thereby controlling the overall operation of each of the components.

The controller 170 may include at least one processor. The controller 170 may control the overall operation of the aerosol-generating device 100 using the processor included therein. Here, the processor may be a general processor such as a central processing unit (CPU). Of course, the processor may be a dedicated device such as an application-specific integrated circuit (ASIC), or may be any of other hardware-based processors.

The controller 170 may perform any one of a plurality of functions of the aerosol-generating device 1000. For example, the controller 170 may perform any one of a plurality of functions of the aerosol-generating device 100 (e.g. a preheating function, a heating function, a charging function, and a cleaning function) according to the state of each of the components provided in the aerosol-generating device 100 and the user's command received through the input/output interface 120.

The controller 170 may control the operation of each of the components provided in the aerosol-generating device 100 based on data stored in the memory 140. For example, the controller 170 may control the supply of a predetermined amount of electric power from the battery 160 to the aerosol-generating module 130 for a predetermined time based on the data on the temperature profile, the user's inhalation pattern, which is stored in the memory 140.

The controller 170 may determine the occurrence or non-occurrence of a puff using the puff sensor included in the sensor module 150. For example, the controller 170 may check a temperature change, a flow change, a pressure change, and a voltage change in the aerosol-generating device 100 based on the values sensed by the puff sensor. The controller 170 may determine the occurrence or non-occurrence of a puff based on the value sensed by the puff sensor.

The controller 170 may control the operation of each of the components provided in the aerosol-generating device 100 according to the occurrence or non-occurrence of a puff and/or the number of puffs. For example, the controller 170 may perform control such that the temperature of the heater is changed or maintained based on the temperature profile stored in the memory 140.

The controller 170 may perform control such that the supply of electric power to the heater is interrupted according to a predetermined condition. For example, the controller 170 may perform control such that the supply of electric power to the heater is interrupted when the stick is removed, when the cartridge is demounted, when the number of puffs reaches the predetermined maximum number of puffs, when a puff is not sensed during a predetermined period of time or longer, or when the remaining capacity of the battery 160 is less than a predetermined value.

The controller 170 may calculate the remaining capacity with respect to the full charge capacity of the battery 160. For example, the controller 170 may calculate the remaining capacity of the battery 160 based on the values sensed by the voltage sensor and/or the current sensor included in the sensor module 150.

The controller 170 may perform control such that electric power is supplied to the heater using at least one of a pulse width modulation (PWM) method or a proportional-integral-differential (PID) method.

For example, the controller 170 may perform control such that a current pulse having a predetermined frequency and a predetermined duty ratio is supplied to the heater using the PWM method. In this case, the controller 170 may control the amount of electric power supplied to the heater by adjusting the frequency and the duty ratio of the current pulse.

For example, the controller 170 may determine a target temperature to be controlled based on the temperature profile. In this case, the controller 170 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

Meanwhile, the controller 170 may perform control such that electric power is supplied to the heater according to a predetermined condition. For example, when a cleaning function for cleaning the heater is selected in response to a command input by the user through the input/output interface 120, the controller 170 may perform control such that a predetermined amount of electric power is supplied to the heater.

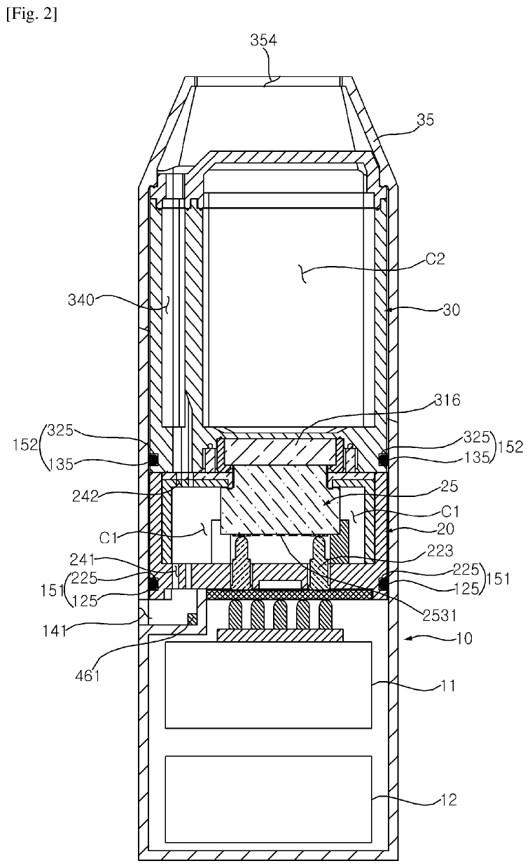

Referring to FIG. 2, the aerosol generating device 100 may include a body 10 and a cartridge (20, 30). The cartridge (20, 30) may include a first container 20 and a second container 30. The cartridge (20, 30) may be coupled to the body 10.

The body 10 may accommodate a power source 11 (e.g., the battery 160 of FIG. 1) and a controller 12 (e.g., the controller 170 of FIG. 1). The power source 11 may supply power required for components to operate. The power source 11 may be referred to as a battery 11. The controller 12 may control the operation of the components.

The first container 20 may include a first chamber C1 therein. The first container 20 may include a wick 25. The wick 25 may be disposed at the first chamber C1. An upper end of the wick 25 may protrude upward of the first container 20 from the first chamber C1.

The first container 20 may include a heater 2531. The heater 2531 may be disposed at the first chamber C1. The heater 2531 may heat the wick 25. The heater 2531 may be attached to the wick 25. The first container 20 may be provided therein with a terminal 223. The terminal 223 may be exposed to a lower side of the first container 20. The terminal 223 may be electrically connected to the heater 2531. The first container 20 may be referred to as a lower container 20 or a heating module 20.

The first container 20 may have a first air flow inlet 241 formed by opening the first chamber C1. The first container 20 may have a first air flow outlet 242 formed by opening the first chamber C1.

The second container 30 may include a second chamber C2 therein. The second container 30 may store liquid in the second chamber C2. The second container 20 may have an air flow discharge path (or air outflow channel) 340. Both ends 341 and 342 of the air flow discharge path 340 may be open. The air flow discharge path 340 may be partitioned from the second chamber C2. The second container 30 may be referred to as an upper container 30 or a liquid storage part 30.

mouthpiece 35 may be coupled on top of the second container 30. The mouthpiece 35 may cover an upper portion of the second container 30. The mouthpiece 35 may have a second air flow outlet 354 therein. The second air flow outlet 354 may communicate with a second end 342 of the air flow discharge path 340.

The first container 20 may be coupled to the body 10. The first container 20 may be inserted into the body 10. When the first container 20 is coupled to the body 10, the heater 2531 may be electrically connected to the power source 11 through the terminal 223. The heater 2531 may generate heat using power supplied from the power source 11. The heater 2531 may be a resistive heater.

The second container 30 may be coupled on top of the first container 20. The coupling of the second container 30 to the first container 20 may include that the second container 30 is directly coupled to the first container 20 and that the second container 30 is indirectly coupled to the first container 20 by being coupled to the body 10.

When the second container 30 is coupled to the first container 20, the second container 30 may supply the stored liquid to the wick 25. The wick 25 may absorb the liquid supplied from the second container 30. The heater 2531 may heat the wick 25 impregnated with the liquid to thereby generate an aerosol in the first chamber C1.

One side of the body 10 may be open to define a second air flow inlet 141. When the first container 20 is coupled to the body 10, the first air flow inlet 241 and the second air flow inlet 141 may communicate with each other. When the second container 30 is coupled to the first container 20, a first end 341 of the air flow discharge path 340 and the first air flow outlet 242 may communicate with each other. Accordingly, a flow path or channel through which air flows may be formed. A user may inhale air while holding the mouthpiece 35 in his or her mouth. When the user inhales the air, air at the outside may sequentially pass through the second air flow inlet 141, the first air flow inlet 241, the first chamber C1, the first air flow outlet 242, the air flow discharge path 340, and the second air flow outlet 354 to be delivered to the user. The air may flow along with the aerosol generated in the first chamber C1.

The puff sensor 461 may output a signal corresponding to the puff. For example, the puff sensor 461 may output a signal corresponding to an internal pressure of the aerosol generating device 100. In this case, the internal pressure of the aerosol-generating device 100 may correspond to the pressure in a flow path through which gas flows. The puff sensor 461 may be disposed at a position corresponding to the flow path through which air flows in the aerosol generating device 100. For example, the puff sensor 461 may be disposed inside the body 10 adjacent to the first air flow inlet 241.

Accordingly, the first container 20 and the second container 30 may be replaced independently of each other. For example, a consumption period of liquid stored in the second container 30 and a proper replacement period of the first container 20 may be different from each other. Only the second container 30 or the first container 20 may be individually replaced by the user. For example, a consumption period of liquid stored in the second container 30 may be shorter than a proper replacement period of the first container 20, and accordingly, the first container 20 may be replaced only once when the second container 30 is replaced several times. As a result, the first container 20 may be used longer to thereby reduce the replacement cost of the cartridge.

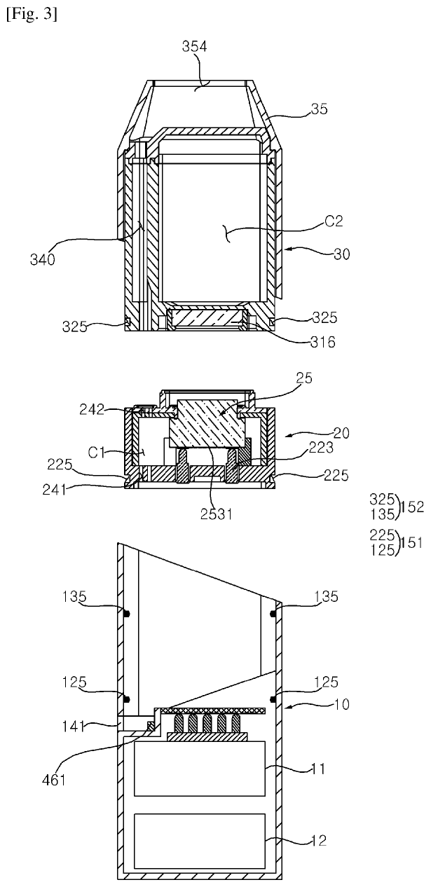

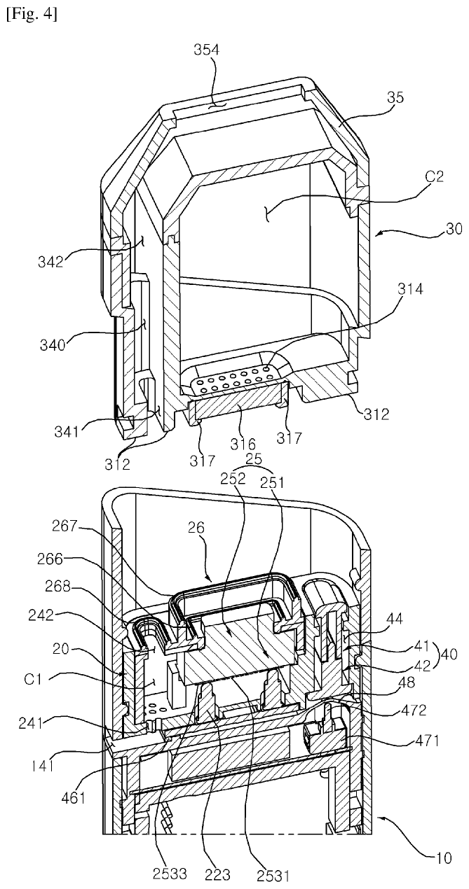

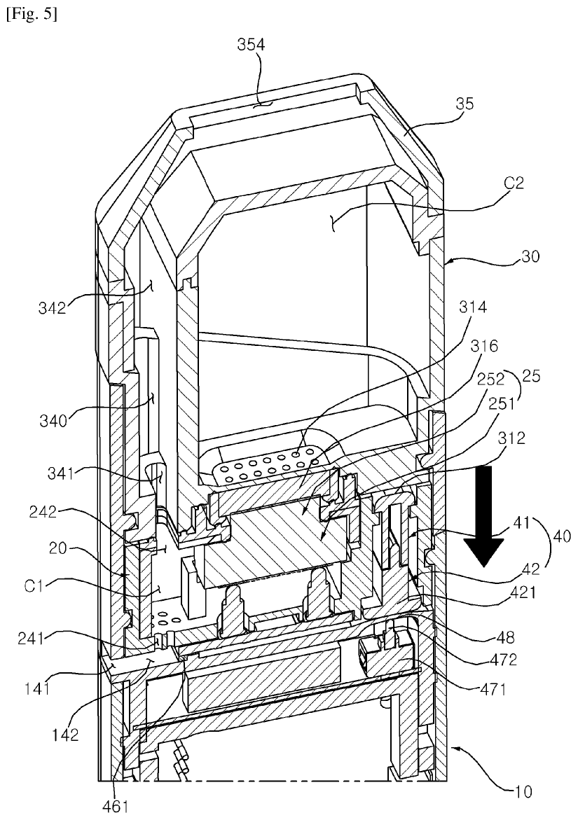

Referring to FIGS. 3 to 5, the first container 20 may be detachably coupled to the body 10. A first coupler 151 may allow the first container 20 and the body 10 to be detachably coupled to each other. For example, the first coupler 151 may include a hook recess 225 and a hook 125 detachably fastened to the hook recess 225. The hook 125 may be made of a material such as rubber or silicone to seal between the body 10 in the vicinity of the second air flow inlet 141 and the first container 20. As another example, the first coupler 151 may use a magnetic force to allow the first container 20 and the body 10 to be coupled to each other.

The second container 30 may be detachably coupled to the first container 20. The second container 30 may be coupled on top of the first container 20. The second container 30 may be coupled to the body 10 so as to be indirectly coupled to the first container 20. A second coupler 152 may allow the second container 30 and the body 10 to be detachably coupled to each other. For example, the second coupler 152 may include a hook recess 325 and a hook 135 detachably fastened to the hook recess 325. As another example, the second coupler 152 may use a magnetic force to allow the second container 30 and the body 10 to be coupled to each other.

The first container 20 may be detachably coupled to the body 10. The first coupler 151 may allow the first container 20 and the body 10 to be detachably coupled to each other. The second container 30 may be detachably coupled to the first container 20. The second container 30 may be coupled to the body 10 through the second coupler 152, allowing the second container 30 to be indirectly coupled to the first container 20. The second container 30 may be coupled on top of the first container 20.

When the second container 30 is coupled to the first container 20, the second container 30 may supply liquid to the wick 25. The liquid stored in the second chamber C2 may pass through the liquid outlet 314 to be absorbed by the absorbent portion 316. The absorbent portion 316 impregnated with the liquid may come into contact with the second wick part 252, so that the liquid is transferred to the second wick part 252. The liquid absorbed into the second wick part 252 may be distributed into the first wick part 251. The heater 3531 may heat the first wick part 251 impregnated with the liquid to generate an aerosol.

A film may be detachably attached to a lower surface of the absorbent portion 316. An edge of the film may be attached to a lower surface of the bracket 317. The film may be made of a waterproof material. The film may prevent liquid from leaking from the absorbent portion 316. A user may remove the film from the absorbent portion 316 before coupling the second container 30 to the first container 20.

The sealer 26 may seal around the liquid inlet 235 through which the wick 25 is exposed from the first chamber C1. When the second container 30 is coupled on top of the first container 20, the sealer 26 may seal between the first container 20 and the second container 30. The sealing wall 266, 267 may protrude toward the second container 30. The sealing wall 266, 267 may be in close contact with the second container 30. The sealing wall 266, 267 may surround the vicinity of the liquid inlet 235. Accordingly, liquid discharged from the second container 30 may be prevented from leaking into a gap between the first container 20 and the second container 30.

The sealer 26 may include an air flow sealing portion 268. The air flow sealing portion 268 may surround the vicinity of the first air flow outlet 242. The second sealing wall 267 may protrude higher than the air flow sealing portion 268. The air flow sealing portion 268 may be formed outside the sealing walls 266, 267.

The cartridge detection sensor 471 may installed in a body 10. The cartridge detection sensor 471 may sense or detect whether the second container 30 is coupled to the first container 20. Based on sensing by the cartridge detection sensor 471, the controller 12 may control the operation of various components. For example, the cartridge detection sensor 471 may be a contact sensor. The cartridge detection sensor 471 may detect whether the second container 30 is coupled to the first container 20 through physical contact. When the second container 30 is coupled to the first container 20, physical contact on the cartridge detection sensor 471 may occur. The cartridge detection sensor 471 may sense physical contact thereon. For example, the physical contact may be achieved when the cartridge detection sensor 471 comes into direct contact with the second container 30. For example, the physical contact may be achieved through an intermediate component between the cartridge detection sensor 471 and the second container 30.

A pusher 40 may be disposed between the cartridge detection sensor 471 and the second container 30. The pusher 40 may be inserted into the pusher movement path 44. the pusher 40 may include a first pusher part 41 and a second pusher part 42. The first pusher part 41 and the second pusher part 42 may be coupled together up and down. The pusher 40 may be elongated between the cartridge detection sensor 471 and the second container 30. The pusher 40 may move between the cartridge detection sensor 471 and the second container 30. One end (or first end) of the pusher 40 may be adjacent to the second container 30. The one end of the pusher 40 may be exposed toward the second container 30 through the one end of the pusher movement path 44. Another end (or second end) of the pusher 40 may be adjacent to the cartridge detection sensor 471. The another end of the pusher 40 may be exposed toward the cartridge detection sensor 471 through the another end of the pusher movement path 44.

For example, the pusher 40 and the pusher movement path 44 may have a shape elongated vertically. The pusher 40 may be movable up and down (or vertically). When the second container 30 is coupled on the top of the first container 20, as a lower portion 312 of the second container 30 contacts the upper end of the pusher 40 and presses the pusher 40 downward, the lower end of the pusher 40 may contact the cartridge detection sensor 471.

The cartridge detection sensor 471 may transmit a sensing signal corresponding to physical contact to the controller 12. The controller 12 may determine whether the second container 30 is coupled to the first container 20 based on the sensing signal received from the cartridge detection sensor.

Accordingly, coupling of the second container 30 to the first container 20 may be sensed by the cartridge detection sensor 471 without an additional terminal component for electrical connection. Accordingly, the configuration of the second container 30 for sensing may be simplified to thereby reduce the manufacturing cost. In addition, when it is determined whether or not to couple to the second container 30 using a physical contact method, the influence of external noise may be small to thereby increase the sensing accuracy.

An actuator 472 may be pressed by the pusher 40, so that physical contact is transmitted or applied to the cartridge detection sensor 471. The actuator 472 may be integrally formed with the cartridge detection sensor 471. The actuator 472 may protrude long from the cartridge detection sensor 471 toward the pusher 40. The actuator 472 may provide a repulsive force to the pusher 40 in a direction away from the cartridge detection sensor 471. The actuator 472 may provide a repulsive force to the pusher 40 in a direction from the another end toward the one end of the pusher movement path 44. For example, the actuator 472 may provide a repulsive force that pushes the pusher 40 upward.

When the second container 30 is coupled to the first container 20, the pusher 40 may press the actuator 472 toward the cartridge detection sensor 471. When the pusher 40 presses the actuator 472 toward the cartridge detection sensor 471, the cartridge detection sensor 471 may sense physical contact. When the second container 30 is separated from the first container 20, the pusher 40 may move in a direction away from the cartridge detection sensor 471 due to the repulsive force of the actuator 472, and the pressed state of the cartridge detection sensor 471 may be released. The pusher 40 may be returned to a position before the second container 30 is coupled to the first container 20.

A sealing membrane 48 may be provided between the cartridge detection sensor 471 and the pusher movement path 44. The sealing membrane 48 may be provided between the actuator 472 and the pusher movement path 44. The sealing membrane 48 may be made of a material having elasticity to allow shape deformation. For example, the sealing membrane 48 may be made of rubber or silicone.

In an embodiment in which the actuator 472 pushes the sealing membrane 48, the sealing membrane 48 may have a convex shape toward the pusher 40. When the pusher 40 presses the cartridge detection sensor 471, the sealing membrane 48 may be reduced in curvature or be deformed convexly toward the cartridge detection sensor 471. Accordingly, the sealing membrane 48 may prevent foreign substances, such as liquid, from leaking around the cartridge detection sensor 471 through the pusher movement path 44.

In the present disclosure, the cartridge detection sensor 471 is described as being a contact sensor, but embodiments are not limited thereto. According to one embodiment, the cartridge detection sensor 471 may be a non-contact sensor. For example, the cartridge detection sensor 471 may be one of a magnetic proximity sensor, an optical proximity sensor, an ultrasonic proximity sensor, an inductive proximity sensor, a capacitive proximity sensor, and an eddy current proximity sensor.

According to one embodiment, whether or not the first container 20 is coupled to the body 10 may be detected by a separate sensor or by an electrical connection between the terminal 223 and the power source 11.

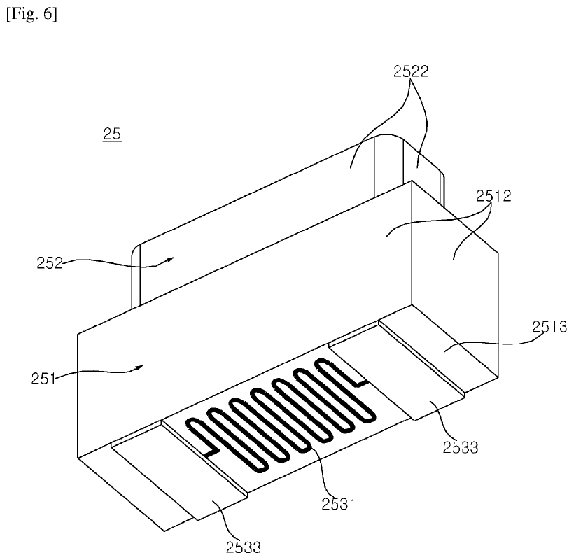

Referring to FIG. 6, the wick 25 may be made of a porous rigid body to absorb liquid. For example, the wick 25 may be made of a porous ceramic. The wick 25 may have greater rigidity or heat resistance than a cotton wick.

Accordingly, the wick 25 may have little or no deformation, and may be implemented in various shapes. In addition, durability of the wick 25 may be improved, and a replacement period of the first container 20 having the wick 25 may be extended.

The first wick part 251 may be elongated in one horizontal direction. The first wick part 251 may have a hexahedral shape. The second wick part 252 may protrude upward from a middle of the upper surface 2511 of the first wick part 251. The second wick part 252 may be elongated in the horizontal direction. The second wick part 252 may have a hexahedral shape.

The first wick part 251 may be larger in size than the second wick part 252. A periphery corresponding to a lateral surface 2512 of the first wick part 251 may be greater than a periphery corresponding to a lateral surface 2522 of the second wick part 252.

The heater 2531 may be attached to the first wick part 251. The heater 2531 may form a pattern on the lower surface 2513 of the first wick part 251. The heater 2531 may form various patterns along a longitudinal direction of the first wick part 251. Opposite ends of the heater 2531 may be adjacent to opposite ends of the first wick part 251.

A pair of first terminals 2533 may be provided at opposite end portions of the heater 2531. The first terminal 2533 may be coupled to the lower surface 2513 of the first wick part 251. The pair of first terminals 2533 may be adjacent to the opposite ends of the first wick part 251. The first terminal 2533 may protrude downward from the first wick part 251.

The first terminal 2533 may come into contact with the second terminal 223 to allow the heater 2531 and the second terminal 223 to be electrically connected to each other. The second terminal 223 may support the first terminal 2533 and the lower surface 2513 of the first wick part 251.

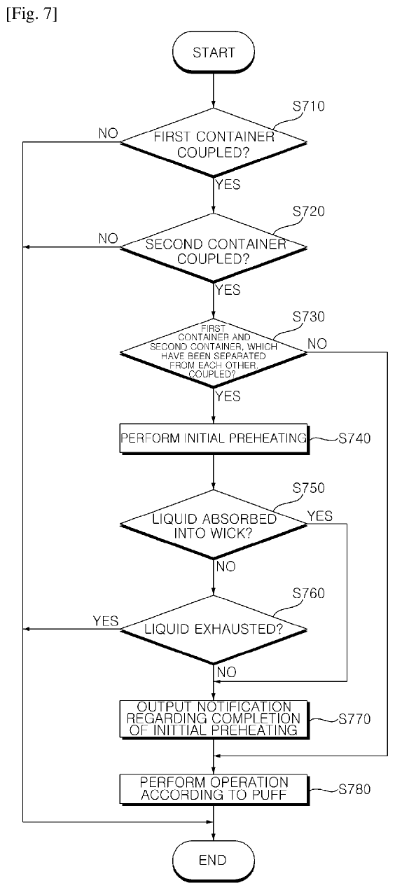

FIG. 7 is a flowchart showing an operation method of the aerosol-generating device according to an embodiment of the present disclosure; and

Referring to FIG. 7, the aerosol generating device 100 may determine whether or not the body 10 and the first container 20 are coupled in operation S710. For example, the aerosol generating device 100 may determine whether the body 10 and the first container 20 are coupled based on whether the power source 11 included in the body 10 and the second terminal 223 included in the first container 20 are electrically connected to each other.

The aerosol generating device 100 may determine whether the first container 20 and the second container 30 are coupled in operation S720. For example, the aerosol generating device 100 may determine that the first container 20 and the second container 30 are coupled based on a detection signal corresponding to the physical contact being output from the cartridge detection sensor 471. In this case, when the first container 20 and the second container 30 are coupled, the body 10 and the second container 30 may also be coupled.

When the first container 20 and/or the second container 30 are not coupled to the body 10, the aerosol generating device 100 may deactivate the operation of at least one component provided on the body 10 or the like. For example, when at least one of the first container 20 and the second container 30 is not coupled to the body 10, the aerosol generating device 100 may interrupt supply of power to the heater 2531 and the puff sensor 461. For example, when the body 10 and the first container 20 are not coupled, the aerosol generating device 100 may interrupt supply of power to the cartridge detection sensor 471.

When it is determined that the first container 20 and the second container 30 are coupled, the aerosol generating device 100 may determine whether the first container 20 and the second container 30, which have been separated from each other, are coupled in operation S730. For example, the aerosol generating device 100 may determine that the first container 20 and the second container 30 are separated while the detection signal corresponding to the physical contact is not output from the cartridge detection sensor 471. At this time, the aerosol generating device 100 may determine that the first container 20 and the second container 30, which have been separated from each other, are coupled based on the detection signal corresponding to the physical contact being output from the cartridge detection sensor 471.

The aerosol generating device 100 may perform preheating corresponding to the combination of the first container 20 and the second container 30 (hereinafter referred to as initial preheating) in operation S740, based on the combination of the first container 20 and the second container 30, which have been separated from each other. For example, the aerosol generating device 100 may supply power corresponding to initial preheating (hereinafter, referred to as initial power) to the heater 2531 when the first container 20 and the second container 30, which have been separated from each other, are combined. In this case, the initial power may be lower than the power supplied to the heater 2531 to generate aerosol.

When the first container 20 and the second container 30 are coupled, the liquid stored in the second chamber C2 may flow to the wick 25 via the absorbent portion 316. When the liquid is not absorbed by the wick 25, it may take a considerable amount of time for the wick 25 to sufficiently absorb the liquid to generate an aerosol. In this case, when a temperature of the heater 2531 increases due to the initial power supplied to the heater 2531, the temperature of the liquid flowing in the wick 25 may increase. In addition, when the temperature of the liquid flowing in the wick 25 increases, the viscosity of the liquid decreases so that the liquid may more smoothly flow in the wick 25. Accordingly, the time required for the wick 25 to sufficiently absorb the liquid may be shortened.

The aerosol generating device 100 may determine whether the liquid is absorbed into the wick 25 in operation S750. When the wick 25 does not sufficiently absorb the liquid, the temperature of the heater 2531 may increase above a predetermined level as the initial power is supplied to the heater 2531. On the other hand, when the liquid is sufficiently absorbed by the wick 25, the temperature of the heater 2531 may be maintained, limitedly increase compared to when the liquid is sufficiently absorbed into the wick 25, or be lowered, even if initial power is supplied to the heater 2531. Accordingly, the aerosol generating device 100 may determine whether the liquid is absorbed into the wick 25 based on the temperature of the heater 2531 corresponding to the supply of the initial power.

According to one embodiment, the aerosol generating device 100 may determine that the liquid is not absorbed into the wick 25 when a change in the temperature of the heater 2531 at a first time when the initial power is supplied is equal to or greater than a predetermined first temperature change. According to one embodiment, the aerosol generating device 100 may determine that the liquid is not absorbed into the wick 25 when the temperature of the heater 2531 at the first time when the initial power is supplied exceeds a predetermined first temperature.

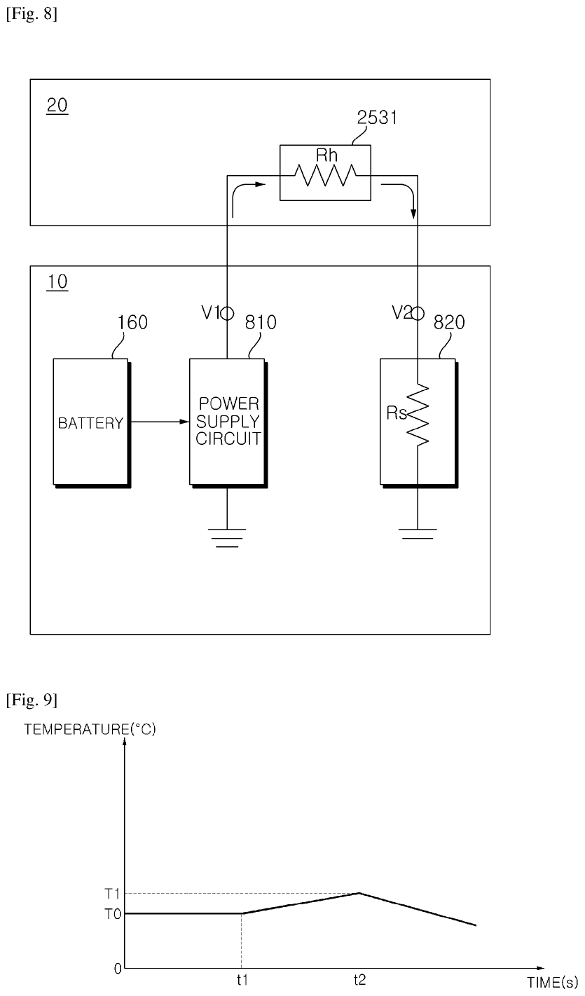

Referring to FIG. 8, the aerosol-generating device 100 may include a power supply circuit 810, a resistance detection sensor 820, a battery 160 and/or a heater 2531.

When the body 10 and the first container 20 are coupled to each other, the resistance detection sensor 820 of the body 10 may be electrically connected to the heater 2531 of the first container 20. For example, the resistance detection sensor 820 may be a current sensor for detecting current.

The power supply circuit 810, which is disposed in the body 10, may supply power to the heater 2531 using the power stored in the battery 160. In this case, the amount of power supplied from the power supply circuit 810 to the heater 2531 may be adjusted under the control of the controller 170.

The power supply circuit 810 may include a converter that converts a voltage output from the battery 160. For example, the power supply circuit 810 may include a buck-converter, a buck-boost converter, a Zener diode, and the like.

The power supply circuit 810 may include at least one switching element, which is operated under the control of the controller 170. In this case, power may be supplied to the heater 2531 in response to operation of the switching element. For example, the switching element may be a bipolar junction transistor (BJT) or a field effect transistor (FET).

When the heater 2531 and the resistance detection sensor 820 are electrically connected to each other, current having the same magnitude may flow through the heater 2531 and the resistance detection sensor 820. Here, the resistance Rs of the shunt resistor provided in the resistance detection sensor 820 may be a value that does not change with temperature.

The controller 170 may determine the voltage V1 applied to the heater 2531 and the resistance detection sensor 820 based on the power supplied from the power supply circuit 810 to the heater 2531 and the current flowing through the heater 2531 and the resistance detection sensor 820. The controller 170 may calculate the voltage V2 applied to the shunt resistor of the resistance detection sensor 820 based on the current flowing through the shunt resistor and the resistance Rs of the shunt resistor. In this case, the controller 170 may calculate the voltage applied to the heater 2531 as the difference (V1−V2) between the voltage V1 applied to the heater 2531 and the resistance detection sensor 820 and the voltage V2 applied to the shunt resistor. In addition, the controller 170 may calculate the resistance Rh of the heater 2531 based on the voltage applied to the heater 2531 and the current flowing through the heater 2531.

Accordingly, the controller 170 may determine the temperature of the heater 2531 in real time based on the current flowing through the heater 2531, which is calculated by the resistance detection sensor 820, even while the wick is being heated by the heater 2531.

Meanwhile, the resistor of the heater 2531 may be a material having a temperature coefficient of resistance, and the resistance Rh of the heater 2531 may vary depending on changes in the temperature of the resistor. The controller 170 may calculate the temperature of the heater 2531 using a calculation equation for calculating the temperature of the heater 2531. Here, the calculation equation used to calculate the temperature of the heater 2531 may be expressed using the following Equation 1.

$$TCR = \frac{R 1 - R 0}{R 0} \div ( T 1 - T 0 ) \qquad [ Equation 1 ]$$

In Equation 1 above, TCR represents the temperature coefficient of resistance of the heater 2531, T1 represents the temperature of the heater 2531, R1 represents the resistance of the heater 2531, T0 represents the reference temperature, and R0 represents the resistance of the heater 2531 at the reference temperature. Here, T0 is 25° C., and R0 is the resistance of the heater 2531 at 25° C.

Although the current sensor is illustrated in this drawing as being connected in series to the heater 2531, the present disclosure is not limited thereto. A temperature sensor disposed adjacent to the heater 2531 to detect the temperature of the heater 2531 or a voltage sensor for detecting the voltage applied to the heater 2531 may be provided as the resistance detection sensor 820.

The aerosol generating device 100 may determine whether the liquid stored in the second cartridge 30 is exhausted when the liquid is not absorbed into the wick 25 in operation S760. When the liquid is stored in the second container 30, the liquid may gradually flow to the wick 25 via the absorbent portion 316. In contrast, when no liquid is stored in the second container 30, the liquid cannot be absorbed into the wick 25 even after a certain period of time has elapsed. Accordingly, the aerosol generating device 100 may determine whether the liquid is stored in the second container 30 based on the temperature of the heater 2531 corresponding the supply of the initial power.

According to one embodiment, the aerosol generating device 100 may determine that the liquid is exhausted when the change in the temperature of the heater 2531 at a second time when the initial power is supplied after the first time has elapsed is equal to or greater than a predetermined second temperature change. In this case, the second temperature change may be less than or equal to the first temperature change. According to one embodiment, the aerosol generating device 100 may determine that the liquid is exhausted when the temperature of the heater 2531 at the second time when the initial power is supplied after the first time has elapsed exceeds a second temperature. In this case, the second temperature may exceed the first temperature.

Referring to FIG. 9, when the first container 20 and the second container 30 are coupled at t1, the aerosol generating device 100 may supply the initial power P0 to the heater 2531. The aerosol generating device 100 may supply the initial power P0 to the heater 2531 from t1 to t2 when the first time elapses. At this time, the temperature of the heater 2531 may increase from T0 to T1 according to the supply of the initial power P0.

A difference between T0 and T1 corresponding to the change in the temperature of the heater 2531 at the first time may be less than the predetermined first temperature change. At this time, since the change in the temperature of the heater 2531 at the first time when the initial power is supplied is less than the predetermined first temperature change, the aerosol generating device 10 may determine that the liquid is absorbed into the wick 25.

When it is determined that the liquid is absorbed by the wick 25, the aerosol generating device 10 may end the supply of the initial power to the heater 2531. At this time, as the supply of the initial power to the heater 2531 ends, the temperature of the heater 2531 may decrease again.

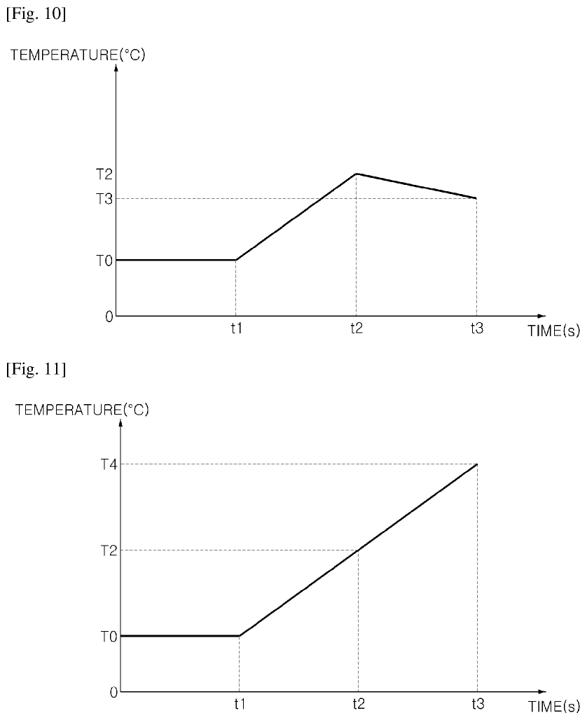

Referring to FIG. 10, when the first container 20 and the second container 30 are coupled at t1, the aerosol generating device 100 may supply the initial power P0 to the heater 2531. The aerosol generating device 100 may supply initial power P0 to the heater 2531 from t1 to t2 when the first time elapses. At this time, the temperature of the heater 2531 may increase from T0 to T2 according to the supply of the initial power P0.

A difference between T0 and T2 corresponding to the change in the temperature of the heater 2531 at the first time may be greater than or equal to the predetermined first temperature change. At this time, since the change in the temperature of the heater 2531 at the first time when the initial power is supplied is equal to or greater than the predetermined first temperature change, the aerosol generating device 10 may determine that the liquid is not absorbed by the wick 25.

Meanwhile, when it is determined that the liquid is not absorbed by the wick 25, the aerosol generating device 10 may continue to supply the initial power to the heater 2531 even after t2. At this time, when the liquid sufficiently flows into the wick 25 for the first time, the temperature of the heater 2531 may gradually decrease despite the supply of initial power. For example, the temperature of the heater 2531 may be lowered from T2 to T3 from t2 to t3 when the second time elapses.

A difference between T2 and T3 corresponding to the change in the temperature of the heater 2531 at the second time may be less than the predetermined second temperature change. At this time, since the change in the temperature of the heater 2531 at the second time when the initial power is supplied is less than the predetermined second temperature change, the aerosol generating device 10 may determine that the liquid is sufficiently stored in the second container 30.

Meanwhile, referring to FIG. 11, similarly to FIG. 10, when it is determined that the liquid is not absorbed into the wick 25, the aerosol generating device 10 may continue to supply the initial power to the heater 2531 even after t2. In this case, when the liquid does not sufficiently flow into the wick 25 for the first time, the temperature of the heater 2531 may continue to increase due to the supply of the initial power. For example, the temperature of the heater 2531 may increase from T2 to T4 from t2 to t3 when the second time elapses.

A difference between T2 and T4 corresponding to the change in the temperature of the heater 2531 at the second time may be greater than or equal to the predetermined second temperature change. At this time, since the change in the temperature of the heater 2531 at the second time when the initial power is supplied exceeds the predetermined second temperature change, the aerosol generating device 10 may determine that no liquid is stored in the second container 30.

According to an embodiment, the aerosol generating device 100 may deactivate the operation of at least one component provided in the body 10 or the like when the liquid stored in the second container 30 is exhausted. For example, the aerosol generating device 100 may interrupt the supply of power to the heater 2531 and the puff sensor 461 when the liquid stored in the second container 30 is exhausted. In this case, the aerosol generating device 100 may interrupt the supply of power to the heater 2531 and the puff sensor 461 until the first container 20 and the second container 30 are separated.

Meanwhile, when the liquid is stored in the second container 30, the aerosol generating device 100 may supply initial power to the heater 2531 for a time corresponding to the initial power (hereinafter referred to as initial time). In this case, the predetermined initial time may be set according to a time required for the liquid to flow from one side of the second wick part 252 adjacent to the absorbent portion 316 to one side of the first wick part 251 adjacent to the heater 2531. The initial time may include the first time and the second time. For example, when it is determined that the liquid is not absorbed by the wick 25 and the liquid is stored in the second container 30, the aerosol generating device 100 may supply the initial power to the heater 2531 while the initial time elapses from when the first container 20 and the second container 30 are coupled.

The aerosol generating device 100 may output a notification regarding completion of the initial preheating in operation S770. For example, when initial power is supplied to the heater 2531 for the initial time, the aerosol generating device 100 may output a notice regarding the completion of the initial preheating. For example, when it is determined that the liquid is absorbed into the wick 25, the aerosol generating device 100 may output a notice regarding the completion of the initial preheating.

According to one embodiment, the aerosol generating device 100 may output the notification regarding the completion of the initial preheating through an output device included in the input/output interface 120. For example, when the initial power is supplied to the heater 2531 for the initial time, the aerosol generating device 100 may output light corresponding to the completion of the initial preheating through a light emitting diode (LED). For example, when the initial power is supplied to the heater 2531 for the initial time, the aerosol generating device 100 may generate a vibration corresponding to the completion of the initial preheating through a motor.

The aerosol generating device 100 may perform an operation according to the puff when the first container 20 and the second container 30 are coupled in operation S780. For example, the aerosol generating device 100 may supply power corresponding to generating the aerosol (hereinafter, heating power) to the heater 2531 based on the puff being detected in the state in which the first container 20 and the second container 30 are coupled. For example, the aerosol generating device 100 may perform preheating corresponding to the end of the puff (hereinafter, preheating between puffs) based on the end of the puff in the state in which the first container 20 and the second container 30 are coupled. In this case, when the preheating between puffs is performed, the aerosol generating device 100 may supply power corresponding to the preheating between puffs (hereinafter, preheating power) to the heater 2531. In this case, the preheating power may be less than the heating power supplied to the heater 2531 to generate the aerosol. The initial power and the preheating power may be different from each other. Meanwhile, the aerosol generating device 100 may interrupt supply of power to the heater 2531 when any puff is not detected for a certain period of time after the puff ends.

According to one embodiment, the initial power may be adjusted according to an environmental temperature. For example, the aerosol generating device 100 may increase the initial power as the environmental temperature decreases. Meanwhile, the preheating power may be supplied to the heater 2531 in a predetermined level regardless of the environmental temperature.

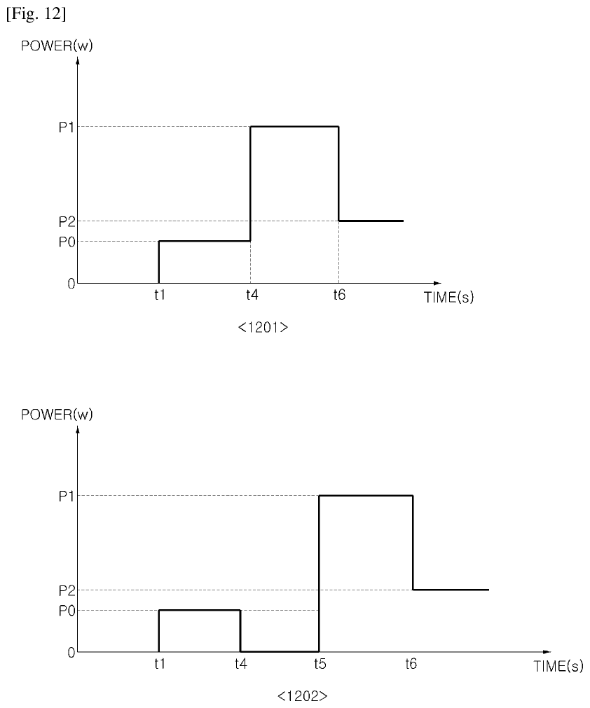

Referring to reference numeral 1201 in FIG. 12, supply of power to the heater 2531 may be interrupt while the first container 20 and the second container 30 are separated.

When the first container 20 and the second container 30 are coupled at t1, the aerosol generating device 100 may supply the initial power P0 to the heater 2531. The aerosol generating device 100 may supply the initial power P0 to the heater 2531 from t1 to t4 when the predetermined initial time has elapsed.

When a puff is sensed at t4 when the initial preheating is completed, the aerosol generating device 100 may supply the heating power P1 to the heater 2531. The aerosol generating device 100 may supply the heating power P1 to the heater 2531 from t4 when the puff is sensed to t6 when the puff ends.

The aerosol generating device 100 may supply the preheating power P2 to the heater 2531 from t6 when the puff ends.

Meanwhile, referring to reference numeral 1202 in FIG. 12, the aerosol generating device 100 may supply the initial power P0 to the heater 2531 from t1 when the first container 20 and second container 30 are coupled to t4 when the predetermined initial time has elapsed.

The aerosol generating device 100 may interrupt the supply of power to the heater 2531 from t4 when the initial preheating is completed. In this case, the aerosol generating device 100 may monitor whether a puff is detected while the supply of power to the heater 2531 is interrupted.

The aerosol generating device 100 may supply the heating power P1 to the heater 2531 at t5 when the puff is detected.

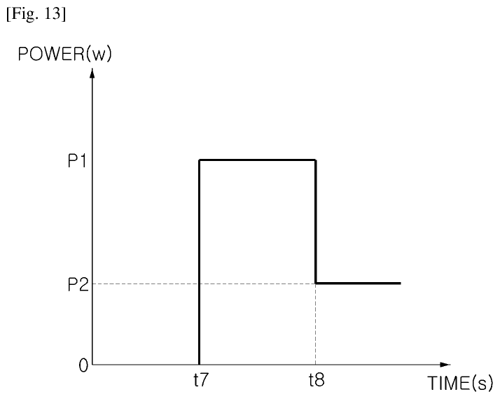

Referring to FIG. 13, supply of power to the heater 2531 may be interrupted in a state in which the first container 20 and the second container 30 are coupled. The aerosol generating device 100 may monitor whether a puff is detected in the state in which the first container 20 and the second container 30 are coupled and the supply of power to the heater 2531 may be interrupted.

The aerosol generating device 100 may supply the heating power P1 to the heater 2531 at t7 when the puff is sensed. The aerosol generating device 100 may supply the heating power P1 to the heater 2531 from t7 when the puff is detected to t8 when the puff ends.

The aerosol generating device 100 may supply the preheating power P2 to the heater 2531 from t8 when the puff ends.

As described above, according to at least one of the embodiments of the present disclosure, it may be possible to allow a liquid to flow smoothly to a wick for generating aerosol.

In addition, according to at least one of the embodiments of the present disclosure, it may be possible to allow a liquid to flow smoothly to a wick for generating aerosol.

In addition, according to at least one of the embodiments of the present disclosure, it may be possible to notify a user that a liquid has sufficiently flowed into a wick.

In addition, according to at least one of the embodiments of the present disclosure, it may be possible to reduce unnecessary power consumption.

In addition, according to at least one of the embodiments of the present disclosure, it may be possible to determine whether a liquid is absorbed into a wick before generating an aerosol.

In addition, according to at least one of the embodiments of the present disclosure, it may be possible to determine whether a liquid is stored in a cartridge prior to generating the aerosol.

Referring to FIGS. 1 to 13, an aerosol-generating device 10 in accordance with one aspect of the present disclosure may include a first container 20 including a wick 25 and a heater 2531, a second container 30 configured to store a liquid, a first sensor 471 configured to detect a coupling between the first container 20 and the second container 30, a second sensor 820 configured to sense a temperature of the heater 2531 and a controller. The first container 20 and the second container 30 may be detachably coupled to each other. The controller 170 may control so that initial power corresponding to coupling of the first container 20 and the second container 30 is supplied to the heater 2531, based on the first container 20 and the second container 30 which have been separated from each other being coupled, and determine at least one of whether the liquid is absorbed into the wick 25 or whether the liquid in the second container 30 is exhausted, based on a temperature of the heater 2531 corresponding to supply of the initial power.

In addition, in accordance with another aspect of the present disclosure, the controller 170 may interrupt supply of power to the heater 2531 until the first container 20 and the second container 30 are separated, based on a determination that the liquid in the second container 30 is exhausted.

In addition, in accordance with another aspect of the present disclosure, the controller 170 may determine that the liquid is exhausted based on the temperature of the heater 2531 exceeding a predetermined reference temperature, and determine that the liquid is not exhausted based on the temperature of the heater 2531 being equal to or less than the reference temperature.

In addition, in accordance with another aspect of the present disclosure, the controller 170 may determine whether the liquid is absorbed in the wick 25 based on a change in the temperature of the heater 2531 at a first time when the initial power is supplied, determine that the liquid is not exhausted based on a determination that the liquid is absorbed into the wick 25, and determine whether the liquid is exhausted based on a change in the temperature of the heater 2531 after the first time elapses based on a determination that the liquid is not absorbed into the wick 25.

In addition, in accordance with another aspect of the present disclosure, controller 170 may determine that the liquid is not exhausted based on the change in the temperature of the heater 2531 at a second time when the initial power is supplied after the first time has elapsed being less than a predetermined temperature change, and determine that the liquid is exhausted based on the change in the temperature of the heater 2531 at the second time being equal to or greater than the predetermined temperature change.

In addition, in accordance with another aspect of the present disclosure, the aerosol-generating device 10 may further comprise a third sensor 461 configured to detect a puff. The controller 170 may determine whether the liquid is absorbed in the wick 25 based on a change in the temperature of the heater 2531 at a first time when the initial power is supplied, and end supply of the initial power based on the liquid being absorbed into the wick 25.

In addition, in accordance with another aspect of the present disclosure, the controller 170 may determine that the liquid is absorbed in the wick 25 based on a change in the temperature of the heater 2531 at a first time when the initial power is supplied being less than a predetermined temperature change, and determine that the liquid is not absorbed in the wick 25 based on the change in the temperature of the heater 2531 at the first time being equal to or greater than the predetermined temperature change.

In addition, in accordance with another aspect of the present disclosure, the aerosol-generating device 10 may further comprise a third sensor 461 configured to detect a puff. The controller 170 is configured to control so that the initial power is supplied to the heater 2531 for an initial time corresponding to the initial power, based on a determination that the liquid is not exhausted, and monitor whether the puff is detected, based on elapse of the initial time.

In addition, in accordance with another aspect of the present disclosure, the aerosol-generating device 10 may further comprise an interface 120 configured to output a notification to a user. The controller 170 is configured to control so that the initial power is supplied to the heater 2531 for an initial time corresponding to the initial power, based on a determination that the liquid is not exhausted, and output, through the interface 120, the notification, based on elapse of the initial time.

In addition, in accordance with another aspect of the present disclosure, the aerosol-generating device 10 may further comprise a body 10 having the controller. the controller 170 may monitor whether the first container 20 and the second container 30 are coupled, in a state in which the body 10 and the first container 20 are coupled.

In addition, in accordance with another aspect of the present disclosure, the wick 25 may comprise a first wick part 251 disposed inside the first container 20 and a second wick part 252 disposed to be exposed to outside of the first container 20 through a liquid inlet of the first container 20. The heater 2531 may be disposed in contact with the first wick part 251.

In addition, in accordance with another aspect of the present disclosure, the second container 30 may comprise a chamber C2 configured to store the liquid and an absorbent portion 316 configured to absorb the liquid. The absorbent portion 316 may be disposed to be exposed to outside of the second container 30. The liquid absorbed in the absorbent portion may be supplied to the first container 20 in response to the first container 20 and the second container 30 are coupled.

In addition, in accordance with another aspect of the present disclosure, the wick 25 may be made of a ceramic.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a first container including a wick and a heater;
a second container shaped to store a liquid and being configured to detachably couple with the first container;
a first sensor configured to detect coupling of the first container with the second container;
a second sensor configured to sense a temperature of the heater; and
a controller is configured to:
cause supply of initial power to the heater, based on the first sensor detecting the coupling of the first container with the second container, and
determine at least one of whether the liquid is absorbed into the wick, or whether the liquid in the second container is exhausted, based on the temperature of the heater during the supply of the initial power to the heater.

2. The aerosol-generating device according to claim 1, wherein the controller is further configured to interrupt supply of power to the heater, based on the determination that the liquid in the second container is exhausted.

3. The aerosol-generating device according to claim 1, wherein the controller is further configured to:
determine that the liquid in the second container is exhausted, based on the temperature of the heater exceeding a predetermined reference temperature, and
determine that the liquid in the second container is not exhausted, based on the temperature of the heater being equal to or less than the reference temperature.

4. The aerosol-generating device according to claim 1, wherein the controller is further configured to:
determine whether the liquid is absorbed into the wick, based on a change in the temperature of the heater at a first time during the supply of the initial power to the heater,
determine that the liquid in the second container is not exhausted, based on the determination that the liquid is absorbed into the wick, and
determine whether the liquid in the second container is exhausted, based on a change in the temperature of the heater, after the first time elapses, based on the determination that the liquid is not absorbed into the wick.

5. The aerosol-generating device according to claim 4, wherein the controller is further configured to:
determine that the liquid in the second container is not exhausted, based on the change in the temperature of the heater at a second time being less than a predetermined temperature change, wherein the second time is after the first time has elapsed and is during the supply of the initial power to the heater, and
determine that the liquid in the second container is exhausted, based on the change in the temperature of the heater at the second time being equal to or greater than the predetermined temperature change.

6. The aerosol-generating device according to claim 1, further comprising a third sensor configured to detect a puff,
wherein the controller is further configured to:
determine whether the liquid is absorbed into the wick, based on a change in the temperature of the heater at a first time during the supply of the initial power to the heater, and
cause the supply of the initial power to the heater to terminate, based on the liquid being absorbed into the wick.

7. The aerosol-generating device according to claim 1, wherein the controller is further configured to:
determine that the liquid is absorbed into the wick, based on a change in the temperature of the heater at a first time during the supply of the initial power to the heater, wherein the change is less than a predetermined temperature change, and
determine that the liquid is not absorbed into the wick, based on the change in the temperature of the heater at the first time being equal to or greater than the predetermined temperature change.

8. The aerosol-generating device according to claim 1, further comprising a third sensor configured to detect a puff,
wherein the controller is further configured to:
cause the supply of the initial power to the heater for an initial time corresponding to the initial power, based on the determination that the liquid in the second container is not exhausted, and
monitor whether the puff is detected, based on elapse of the initial time.

9. The aerosol-generating device according to claim 1, further comprising an interface configured to output a notification to a user,
wherein the controller is configured to:
cause the supply of the initial power to the heater for an initial time corresponding to the initial power, based on the determination that the liquid in the second container is not exhausted, and
output, through the interface, the notification, based on elapse of the initial time.

10. The aerosol-generating device according to claim 1, further comprising a body having the controller,
wherein the controller is further configured to monitor the coupling of the first container with the second container.

11. The aerosol-generating device according to claim 1, wherein the wick comprises:
a first wick part disposed inside the first container; and
a second wick part disposed to be exposed to outside of the first container through a liquid inlet of the first container,
wherein the heater is disposed in contact with the first wick part.

12. The aerosol-generating device according to claim 1, wherein the second container comprises:
a chamber configured to store the liquid; and
an absorbent portion configured to absorb the liquid,
wherein the absorbent portion is disposed to be exposed to an outside of the second container, and
wherein the liquid absorbed in the absorbent portion is supplied to the first container, based on the coupling of the first container with the second container.

13. The aerosol-generating device according to claim 1, wherein the wick comprises a ceramic.
